(19) United States
(12) Patent Application Publication
(10) Pub. No.: US 2024/0247659 A1
(43) Pub. Date: Jul. 25, 2024

(54) METHOD FOR MONITORING THE OPERATION OF A FAN, APPARATUS AND FAN

(71) Applicant: ZIEHL-ABEGG SE, Künzelsau (DE)

(72) Inventors: Bjoern WENGER, Schrozberg (DE); Jacob KRAUTH, Mainhardt (DE); Fabian MOELLER, Kunzelsau (DE)

(21) Appl. No.: 18/553,679

(22) PCT Filed: Mar. 23, 2022
(86) PCT No.: PCT/DE2022/200055

§ 371 Date: Oct. 2, 2023

(30) Foreign Application Priority Data
Apr. 16, 2021 (DE) 10 2021 203 806.9

(51) Int. Cl. F04D 27/00

(52) U.S. Cl. CPC F04D 27/001

(57) ABSTRACT

A method of monitoring the operation of a fan, wherein the method comprises the following steps of: performing at least one measurement (1) by detecting at least one input signal (2.1, 8.1) over at least one time period, calculating characteristic values (2, 8) of an actual state based on the measured input signals (2.1, 8.1), comparing (3, 9) the calculated characteristic values (2, 8) of at least one actual state with limit values (3.1, 9.1), classifying (4) the actual state on the basis of the comparison (3) either as an anomaly-free normal state (5) or as a general anomaly state (6), and monitoring whether at least one specific anomaly state (12) is present.

### CROSS REFERENCE

This application is a national stage entry application under 35 U.S.C. 371 of PCT Patent Application No. PCT/DE2022/200055, filed on 23 Mar. 2022, which claims priority to German Patent Application No. 10 2021 203 806.9, filed on 16 Apr. 2021, the entire contents of each of which are incorporated herein by reference.

### FIELD

The present disclosure relates to a method for monitoring the operation of a fan, a device for monitoring the operation of a fan, and a fan comprising such a device.

Methods and devices for monitoring the operation of fans of the type in question have been known in practice for years. For example, it is known to perform vibration analyses on rotating machines for early damage detection, for example using acceleration sensors or similar vibration sensor technology. Furthermore, it is known to identify certain damage orders in the process. These are certain multiples of the rotational frequency of the rotating machine. Compared to the rest of the frequency spectrum of the vibration analysis, a noticeable amplitude in the range of a certain damage order indicates a certain anomaly in the operation of the mechanical machine, for example a bearing damage. Certain damage orders—and the associated bearing damage frequencies—can be assigned to individual bearing components, such as an outer ring, an inner ring, a rolling element or a cage of the respective rolling bearing. If a conspicuous amplitude in the frequency spectrum is detected during the vibration analysis, an automatic emergency shutdown is triggered regularly. In the best case, the collected data can then be used to repair or replace the faulty component of the fan causing the anomaly without causing a fatal event, such as a system failure, which can cause high financial damages and/or pose a risk to people and the environment through consequential damages. Despite the downtime in case of anomaly detection, this extends the overall life of the fan.

### SUMMARY

It is therefore the object of the present disclosure to design and further develop a method and a device for monitoring the operation of fans of the type mentioned above in such a way that the operation can be further optimized over the service life of the fan and unnecessary downtimes can be reduced. Furthermore, an improved fan with a correspondingly designed device is to be specified.

According to the present disclosure, the preceding object is solved, in an embodiment, by the features of claim 1. Thereafter, the method in question for monitoring the operation of a fan comprises the following steps of:
performing at least one measurement by detecting at least one input signal over at least one time period,
calculating characteristic values of an actual state based on the measured input signals,
comparing the calculated characteristic values of at least one actual state with limit values,
classifying the actual state on the basis of the comparison either as an anomaly-free normal state or as a general anomaly state, and
monitoring whether at least one specific anomaly state is present.

According to the present disclosure, it has first been recognized that even if an anomaly state is detected, immediate intervention is not necessarily required. Even if individual characteristic values change in the course of the fan's service life in such a way that at some point they lie outside a permissible range of values defined by the limit values, this does not necessarily mean that a damaging event is imminent and must be averted promptly. This reduces unnecessary emergency shutdowns and downtime, and further optimizes operation over the life of the fan.

In addition to avoiding unnecessary downtimes, monitoring can also be possible in particular when the fan is at a standstill and/or in a de-energized state. The operation to be monitored therefore includes the entire use of the fan over the product life and also periods of standstill. This not only prolongs operation from a financial point of view, but also provides real-time monitoring of the system in the sense of passive watching. This can be associated with recommendations for action in the sense of active action, which can, for example, trigger automatic control actions or be directed at a user. This also reduces the application risk that can occur due to system failure.

The acquisition of the at least one input signal over a period of time in each case can occur continuously or at defined points in time. A sensor can record time data over the at least one time period. In the case of an acceleration sensor, the data may be a rotation rate and/or acceleration in one, two, or three spatial axes. The spatial axes can be defined as fixed or circumferential. The acceleration sensor can be assigned to a rotating component or a stationary component of the fan.

The measurements can be evaluated for calculation of the characteristic values via a computing unit of the fan, such as a motor driving the fan. In an embodiment, the motor is an electric motor, such as a brushless DC motor designed as an external rotor motor—EC motor, Electronically Commutated Motor.

According to a further embodiment, data relating to the measurement can be transmitted to other terminals via defined interfaces (I²C, Modbus, CAN, WiFi, . . . ) for further signal processing and/or signal utilization and/or signal storage—at specific times or linked to events. The backup of selected measurements assigned to specific points in time is possible in an internal memory on the device itself or external memories. This data can be used for complaint purposes, for example, wherein a service employee can preferably access the memory. Characteristic data, comparison data, data concerning the classification of the actual state and/or other data relating to monitoring can also be transmitted to other terminals for further signal processing and/or signal utilization. In this way, it is also possible to monitor the operation of the fan via an app, for example on a smartphone or tablet. Furthermore, the data can be visually processed and displayed to an operator on external screens/displays.

From one or more measurements, characteristic values can be calculated that represent the current actual state. If the input signals are acceleration or sound pressure data, amplitudes of the frequency spectrum, for example, can be determined as characteristic values. Especially when diagnosing an anomaly in a rolling bearing, this includes bearing damage frequencies in particular, which can depend on the one hand on the speed and load and on the other hand on the rolling bearing geometry. Characteristic values can depend, for example, on the application, i.e., on specific use cases/application areas/installations, but also on the respective ambient conditions/environmental influences. Characteristic values can further depend, for example, on the rotor speed/rotation rate applied and/or on a load state. Bearing geometry information can also be included in the characteristic value calculation.

The limit values required for the comparison can be determined in advance or in real time in experimental or numerical investigations and limit the maximum permissible range of values of the characteristic values. For each input signal and/or each characteristic value, one or more upper threshold values and/or one or more lower threshold values can thus be defined in order to limit the permissible range of values. Self-configuration of a classifier to classify the states is also possible.

The comparison of calculated characteristic values with limit values allows the classification into two or more states. The comparison can be made over several measurements to increase the robustness of the method to ambient conditions/environmental influences. In the case of detected acceleration data, these interference signals may be external excitations, such as those caused by vibrating or moving bodies, different location factors, or the absolute or relative velocity in a moving application—such as when the fan is operating in an aircraft, train, motor vehicle, or other means of transportation.

Detection of an anomaly state may be erroneously caused by temporary environmental factors or ambient conditions. For the comparison, therefore, the number of all limit value deviations—i.e., the comparisons in which a characteristic value has been recorded above an upper threshold value or below a lower threshold value for the respective limit value—per period can also be considered. Furthermore, it is possible to consider the intensity of a limit value deviation by looking at the relative and/or absolute differences between limit value and characteristic value. Likewise, a rate of change of a characteristic value over time can be taken into account. If, for example, strong fluctuations or rapid changes—also called high gradients—occur within one or more defined time periods, the limit value deviation can be weighted accordingly and taken into account when classifying the actual state.

The actual state can be classified as anomaly-free normal state if regular operation of the fan and/or the EC motor and/or the application is diagnosed. This includes, for instance, natural wear and tear. The actual state can be assessed iteratively by comparing characteristic values with limit values.

The actual state can be classified as a general anomaly state if a significant malfunction of the fan, its EC motor or the application is diagnosed. This state may be due to increased wear, for example. The significant fault can be, for example, bearing damage, contamination of the lubricant, foreign bodies in the rolling bearing, or in the form of erosion of the rolling elements, e.g., due to bearing currents, an imbalance—for example due to contamination, damage to a vane, a minor material failure, a defect or partial defect of electronic components and/or other non-regular influences. However, the primary functions of the system are not necessarily impaired in this case.

The characteristic values may include one or more of the following:
results of one or more previous comparisons,
a rotation rate of the fan,
an acceleration in one, two or three spatial axes, fixed or circumferential,
at least one temperature,
a sound pressure,
a torque,
a pressure, such as an operating or ambient pressure,
humidity values,
measured forces, and/or
virtual values, for example by means of soft sensors.

The totality of all data acquired in a time interval by one or more sensors is the result of a measurement. The temperature may be an ambient temperature. Additionally or alternatively, the temperature may be an operating temperature of the fan, such as a temperature at a particular component, namely one or more transistors, capacitors, heat exchangers, coolants, computing units, resistors, coils, lubricants, mechanical components such as bearings, shafts, permanent magnets.

In further embodiments, further characteristic values can be calculated from one or more characteristic values. Further characteristic values can be:
statistical quantities, such as minimum and maximum values,
percentile values,
standard deviations,
mean values,
classifying/rating quantities, for example by means of a point system similar to a ranking such as for energy efficiency classes, and/or
combinations, for example linear combination of several characteristic values, with uniform or different weighting factors.

In this way, the values of the input signals determined in one or more past measurements can be included in the calculation of individual characteristic values in a suitable manner, depending on the application.

On the one hand, combinations of the above-mentioned variables can be defined and summarized in individual characteristic values, for example, the circulating accelerations in one, two or three room axes, and the rotation rate of the fan, the temperature and humidity values or other suitable combinations.

On the other hand, new characteristic values can be generated from current and previous characteristic values. This is particularly useful if conclusions about the current actual state or future actual states of the fan seem likely. For example, a characteristic value in the form of a counter can also be formed to classify the actual state. For this purpose, a number of defined previous limit deviations is counted as a characteristic value in a counter over time. The counter determines the limit deviations either continuously, i.e., over the totality of all past measurements, or also for measurements within defined periods, in other words for the number of all limit deviations over a defined period, for example for the measurements of the last 30 minutes.

The corresponding limit value or tolerance value for each characteristic value designed as a counter can be relative. For example, the characteristic value designed as a counter can lie outside the tolerance values if 10% limit value deviations have been counted over a defined period or over all measurements. A characteristic value functioning as a counter can also be absolute. For example, the counter may be out of tolerance if 20 limit deviations have been counted in the last 50 measurements or in all measurements.

The counter can additionally take into account current or previous comparisons where the respective characteristic values are within the limit values and no limit value deviation is detected. Then, for example, the counter can be reduced again or counted down. At the next limit value deviation, the counter can be increased or vice versa. In other words, the counter can be incrementing and/or decrementing.

In addition to the frequency of limit value deviations or non limit value deviations, the intensity of a limit value deviation can additionally or alternatively be taken into account for the increase or decrease of the counter. For example, a particularly intensive limit value deviation by a factor of 2 can lead to an increase of the counter by the value 2, a less intensive limit value deviation by a factor of 1.1 can only lead to an increase of the counter by the value 1.1.

The characteristic value calculated in this way can then be compared with a limit value designed as a tolerance value. The classification of the actual state can therefore be done not only by direct comparison of current characteristic values from current input signals of the actual state with limit values, but also with the help of the comparison of a counter with a tolerance value. In other words, an indirect comparison of current and previous characteristic values and limit values can be used to determine a rate of limit value exceedance, which in turn can be a characteristic value.

A combination of direct and indirect comparison is also conceivable when considering several comparisons between characteristic values assigned to the actual state and limit values. For example, the characteristic value formed as a counter can increase by the value ⅔ if two of three limit values are exceeded by the respective other characteristic values.

According to one embodiment, monitoring whether a specific anomaly state exists comprises the following steps:
calculation of specific characteristic values of at least one state on the basis of the measured input signals,
specific comparison of the calculated specific characteristic values with specific limit values, assessment of whether a specific anomaly state exists based on the specific comparison.

This further monitoring can also be performed continuously or at defined times over defined time periods at a defined sampling rate. The specific characteristic values relevant for the assessment of whether a specific anomaly state exists can be calculated from one or more measurements, preferably in the computing unit of the motor. The specific characteristic values may differ from the general characteristic values for classifying the actual state into the anomaly-free state or the general anomaly state, or may be partially or completely identical with these general characteristic values. The specific characteristic values can also depend on the application, i.e., on specific use cases/application areas/installations, but also on the respective ambient conditions/environmental influences. The specific characteristic values can further depend on the rotor speed/rotation rate applied and/or on a load state. Bearing geometry information can also be included in the calculation of the specific characteristic values, for example in the monitoring of specific anomaly states that can be assigned to a rolling bearing. Regarding the variants and design possibilities of the assessment whether a specific anomaly state is present—or whether a specific anomaly state is accordingly not present—reference can furthermore be made to the described variants and design possibilities of the classification of the actual state either as an anomaly-free normal state or as a general anomaly state.

Not every general anomaly state is critical. In addition, not every specific anomaly state is critical. A critical anomaly state is the extreme case of a specific anomaly state. An anomaly state that is not associated with urgent, immediate recommendations for action is therefore an uncritical anomaly state. However, timely maintenance can be recommended. On the other hand, an increased significant fault may also exist and require an emergency shutdown because a fatal event is imminent. Then a critical anomaly state can be assumed.

A critical anomaly may be present when an increased significant fault is diagnosed in the fan, its EC motor or the application. This state may be due to very high wear, for example. Further, it may be pronounced non-regular behavior, such as advanced bearing damage, significant imbalance due to tremendous contamination, severe damage to a blade, advanced material failure, significant defect or partial defect of electronic components, or otherwise increased non-regular influences. In this case, timely intervention is regularly required, because the system behavior is system-critical and can be dangerous for the application, living beings and/or the environment. The intervention can be carried out autonomously by a system—this can be a motor of the fan, its control or also the signal-processing periphery—for example by switching off the motor, or by changing the operating point, such as in the case of strong heat loads. However, intervention can also mean human action.

According to one embodiment, the described monitoring of whether a specific anomaly state exists is performed subsequent to classifying an actual state as a general anomaly state. For example, classifying a current actual state as an anomaly state may be a condition for monitoring whether the current actual state is a specific anomaly state. The correct assessment of the presence of a general, nonspecific anomaly state or a specific anomaly state may exceed 95% in this case. In a further embodiment, a second monitoring of whether a second specific anomaly state exists is performed subsequent to the assessment that a first specific anomaly state exists. In a yet further embodiment, a third monitoring of whether a third specific anomaly state is present is performed only if there is an assessment that a second specific anomaly state is present first, and so on. Thus, multiple specific anomaly states may build upon each other, particularly with respect to the strength of their expression. Here, each specific anomaly state—just like the distinction between anomaly-free normal state and general anomaly state—represents a binary state classifier. Such a serial connection of several diagnoses of a general and then a more and more specific anomaly in several stages, preferably linked by conditions, expands the number of classification states.

In the basic form with two stages—classification as anomaly-free normal state and general anomaly state and assessment of whether a specific anomaly state is present or not—the following three positive classifications are possible:
anomaly-free normal state,
general anomaly state and
specific anomaly state.

Two binary classifications connected in series thus allow a trinary classification. Furthermore, the negative classification is detectable, according to which a general anomaly state is present, but a certain specific anomaly state is not present.

The following condition can be formulated for the serial connection: in order for the next classifier stage—i.e., the next more pronounced specific anomaly state—to be reached, the previous stage must have detected an anomaly state, thus creating a cascade. This is especially true for the highest stage of the specific anomaly state—this is the special case of the critical anomaly.

Further, one or more of the further specific anomaly states may form intermediate stages between the general anomaly state and a critical anomaly state in which there is a significant malfunction of the fan requiring immediate intervention. Here, several intermediate states can be assigned to different expressions of a certain damage pattern or determinable damage patterns. Highest, for example,
a first intermediate stage may correspond to an anomaly state with low expression,
a second intermediate stage to an anomaly state with high expression, and
a third intermediate stage to an anomaly state with dangerous expression before
a critical anomaly state with catastrophic expression is reached.

Each of these anomaly states or intermediate states can be classified in binary terms. Again, monitoring may be performed independently for each anomaly state or intermediate state, or as a function of having previously determined the presence of a more general or less pronounced anomaly state in each case. Each anomaly state or intermediate state thereby forms a binary state classifier. The characteristic values and limit values for each anomaly state or each intermediate stage can be defined differently or overlap in parts. The use of different counters and tolerance values is also possible within the scope of the different diagnoses.

According to another embodiment, monitoring whether a specific anomaly state exists may be independent of any classification of an actual state as a general anomaly state that has occurred at the first stage. Thus, it is possible to diagnose a specific anomaly independently of classifying the current or a preceding actual state as a general anomaly state—for example, to monitor natural wear. Regardless of continuous monitoring of the fan's operation and regardless of how the characteristic and limit values are adjusted automatically or manually after an anomaly state has been detected for the first time, a timely system failure can thus be detected over the entire service life of the fan. For example, when immediate intervention is required, a critical anomaly state is immediately detected, which further improves the diagnosis of the possible anomalies in the operation of the fan and further increases the operational safety. It is also conceivable to monitor for a specific anomaly state both when an actual state is classified as an anomaly state and independently of such classification—for example, at regular times or when some other internal or external condition occurs.

Further specific anomaly states with different expressions can be defined. This allows gradual damage or aging of the fan and/or its motor to be mapped and monitored. For example, a first specific anomaly state may be monitored based on a first specific comparison of a first combination of first specific characteristic values to first specific limit values. A second specific anomaly state can be monitored by a second specific comparison of a second combination of second specific characteristic values with second specific limit values. A third specific anomaly state can be monitored by a third specific comparison of a third combination of third specific characteristic values with third specific limit values, and so on.

Parallel connection of multiple binary classifiers by independently monitoring the different anomaly states allows independent, unconditional binary classification of a state.

One or more binary classifiers can be activated and inactivated independently of each other. Highest, for example, can be illustrated as follows:
a first stage—anomaly state with low expression—is inactive,
a second stage—anomaly state with strong expression—is inactive,
a third stage—anomaly state with dangerous expression—is active,
a fourth stage—critical anomaly state with catastrophic expression—is active.

An advantage of this can be that only anomalies associated with different types of damage or damage patterns are monitored, for example, in the case of a rolling bearing, a specific anomaly associated with the rolling bearing grease, specific anomalies of rolling elements, its inner ring, outer ring, etc. Several classifiers can be provided, which are not necessarily related or dependent on each other. The number of binary classifiers, i.e., the various defined and monitored specific anomaly states, can also be more than four, more than ten, more than 50, more than 100, or any number above this, depending on the application, as long as sufficiently fast data processing seems possible.

In the case of a classification of the actual state as an anomaly-free normal state and/or an assessment that a monitored specific anomaly state is not present, signal feedback may occur. The fed-back data can be used for at least one future measurement. Thus, the result of the classification is available and can be taken into account in the classification or assessment of future measurements as part of state monitoring.

The method may further comprise adjusting the diagnosis taking into account direct or indirect comparisons of characteristic values of at least one past actual state with limit values. Taking into account older characteristic values and comparative data collected over part or all of the service life of the fan and/or its motor can provide a particularly good basis for decision-making in this respect. Furthermore, limit values—similar to the described characteristic values—can be dependent on application cases/areas of use/installations, on a rotor speed/rotation rate and/or on a load state. Adjustment of the classifiers during operation is possible. Their configurations and data, such as calculated characteristic values and/or limit values, for example counters and/or tolerance values, are available to the computing unit at any time and can preferably be transmitted or retrieved via defined interfaces. Depending on the application, different—parameterizable—limit values may be present. Even if limit deviations are present, the system can react tolerantly in order not to immediately classify a current actual state into one of the two states and thus avoid or reduce misclassifications. For example, it can be specified statically or dynamically that one or more specific characteristic values must lie outside the permissible range of values defined by the limit values for a certain number of measurements in succession before an actual state is classified as a general anomaly state. As described, a ratio of limit deviations over a certain number of past measurements is also conceivable. Here, the sensor system can also be recalibrated. The limit values can be newly selected or fixed, so that a system tolerance against exceeding and/or falling below limit values can be changed. The calculation of characteristic values of future actual states, the comparison with limit values or the classification of the actual state based on the comparison can be adjusted. In other words, the diagnosis can be adjusted by the operator or automatically adjusted as a self-learning system on the computing unit or via the defined interfaces as part of the external signal processing.

The characteristic values determined by measurements can be recorded in a log with a time stamp for consideration in the future adjustment of the diagnosis. Data can be shared and/or saved/stored/deposited as part of signal processing, particularly with respect to defining anomaly states and classifiers. Classification results and classifier configurations can be saved together with a timestamp in an internal or external memory and can be read out from there, and/or data can be transferred via communication interfaces, for example streaming to the cloud. In case of permanently occurring limit value deviations, a self-diagnosis and a recalibration of the sensor system can take place. If the sensor system is identified as faulty and cannot be recalibrated, corresponding information is provided that further steps shown cannot be carried out. On the one hand, this information can be stored in protocols and on the other hand, it can be communicated to the outside via the defined interfaces. In the case of permanent limit deviations, the current configuration of the classifier—i.e., the characteristic values and/or limit values associated with the respective monitored general or specific anomaly state—can also be checked and adjusted if necessary.

With regard to the device for monitoring the operation of fans, the above-mentioned object is solved by a device having at least one sensor for detecting at least one input signal over at least one period of time for carrying out at least one measurement, and a computing unit that is designed to carry out the above-described method. The computing unit can be a computing unit of an electric motor of the fan, such as an EC motor. The sensor may be one or more sensors internal to the fan or its motor and/or external sensors. The sensor technology may include one or more of the following: a rate-of-rotation sensor, an accelerometer, a temperature sensor, a microphone, a torque sensor, a pressure sensor, a humidity sensor, a force sensor, and/or virtual sensors/soft sensors.

With regard to the improved fan, the above-mentioned object is solved by a fan comprising a described device for monitoring its operation.

There are now various ways in which the teachings of the present preent disclosure can be advantageously embodied and further developed. For this purpose, reference is made on the one hand to the claims subordinate to claim 1 and on the other hand to the following explanation of exemplary embodiments of the disclosure with reference to the drawings. In connection with the explanation of the exemplary embodiments of the disclosure with reference to the drawing, embodiments and further developments of the teaching are also explained.

### BRIEF DESCRIPTION OF THE SEVERAL VIEWS OF THE DRAWINGS

FIG. 1 a schematic representation of a further first embodiment of the method according to the disclosure.

FIG. 2 a schematic representation of a further second embodiment of the method according to the disclosure.

### DETAILED DESCRIPTION OF THE DISCLOSURE

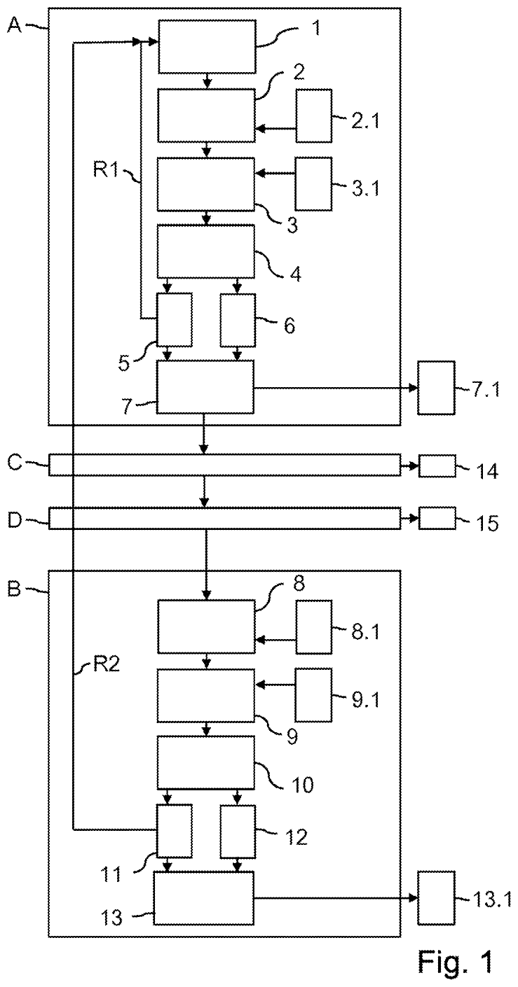

Identical or similar features are marked with the same reference numerals in the figures. FIG. 1 shows a flow chart in general. The upper part schematically shows a diagnosis of an anomaly A within the framework of monitoring an operation of a fan. The starting point for monitoring is a measurement 1 over a period of time. In the example shown here, an internal sensor can detect input signals 2.1 for measurement 1. In the case of an acceleration sensor, these are, for example, the rotation rate and/or acceleration in one, two or three spatial axes. The input signals 2.1 are acquired at a defined sampling rate, either over a defined period per measurement 1 with subsequent defined pauses, or optionally continuously. For example, for measurement 1, input signals 2.1 can be acquired once per minute over a period of 5 seconds at a sampling rate of 1 kHz—i.e., almost continuously. A measurement 1 comprises the totality of all data acquired during the period from input signals 2.1 originating from one or more internal or external sensors. This measurement 1 is examined below. Measurements 1 can be evaluated by the computing unit (not shown) of the motor and/or by transmission to further end devices via defined interfaces (I²C, Modbus, CAN, WiFi, . . . ), so that tracking of the state monitoring is also possible via app/displays. From a measurement 1, characteristic values 2 are calculated, which represent a current actual state. In the case of acceleration or sound pressure data, these include amplitudes of the frequency spectrum.

An example for the calculation of further characteristic values from one or more characteristic values can be given by the following case at the rolling bearing:
a) a first specific comparison leads to the assessment that a first specific anomaly state indicating a non-critical anomaly at the inner ring is present,
b) a second specific comparison leads to the assessment that a second specific anomaly state indicative of an inner ring anomaly is not present; and
c) a third specific comparison leads to the assessment that a third specific anomaly state indicative of a non-critical anomaly associated with the rolling bearing grease is present.

A corresponding new further characteristic value can be defined depending on which and how many specific comparisons indicate which type and/or severity and/or expression of anomaly. In this example, it can be defined that a limit deviation exists as soon as the majority opinion—namely the first and third comparison compared to the second comparison—detects an anomaly. From this, it can then even be concluded that a critical anomaly is present and an action is necessary, even if the first and third specific anomaly states are each merely non-critical anomaly states.

Calculated characteristic values 2 from a measurement 1 are compared with limit values 3.1. Suitable limit values 3.1 for this comparison 3 may have been determined in experimental or numerical investigations and limit the maximum permissible range of values of characteristic values 2. The comparison 3 of calculated characteristic values 2 with limit values 3.1 allows a classification 4 or classification of the actual state into two or more states, such as an anomaly-free normal state 5 or an anomaly state 6. The comparison 3 can be made over several measurements 1 to increase the robustness of the method against disturbance variables from the environment or from the ambient.

For comparison 3, the number and/or intensity of limit deviations per period and/or the rate of change of limit deviations—gradients—are considered. If, for example, particularly strong fluctuations or rapid changes occur within a defined period, i.e., if there are high gradients, the deviation of the characteristic values 2 from the limit values 3.1 is weighted accordingly. The system can then react tolerantly so as not to immediately classify the actual state into one of the states. Thus, incorrect classifications 4 are avoided. In case of permanently occurring limit value deviations, a self-diagnosis of the sensor system takes place and, if necessary, a recalibration. If the sensor system is identified as faulty and cannot be recalibrated, corresponding information is provided that further steps shown cannot be carried out. On the one hand, this information is stored in protocols and/or on the other hand, it is communicated to the outside via defined interfaces. If the actual state is classified as an anomaly-free normal state 5, an initial signal feedback R1 can be made for future measurements 1. The result of the classification of the actual state as an anomaly-free normal state 5 or as a general anomaly state 6 is transmitted to the outside by means of an output signal 7 via defined interfaces for further signal processing 7.1. For example, an optional signal device (display, LED, loudspeaker) integrated or mountable in the EC motor can inform a user in real time in analog/digital, acoustic and/or visual form about the current actual status. The present actual state is recorded in a log together with a time stamp. This log can be read out in real time or for later maintenance purposes via defined interfaces or also displayed with an app. In addition, the classification result can be saved in an internal or external memory and/or communicated to the outside via the defined interfaces. Furthermore, the adjustment of binary classifiers based on the protocol is possible. This may include adjusting the characteristic values 2 and/or limit values 3 or the counter/tolerance values. However, provided that something has changed in the application of the system, it may also be useful to adjust the input signals 2.1, for example, if a user uses a different inlet nozzle, positions the fan in a different manner, etc. It is possible to adjust all factors that contribute to the classification of the actual state 4. Signal processing 7.1 can alternatively or additionally take place in the computing unit and cause an emergency shutdown or operational changes. Signal processing 7.1 may also result in human intervention. This can be indicated to the user, for example, by signal lights, sirens or similar means.

In the lower part of FIG. 1, a more advanced diagnosis of a specific anomaly B is shown schematically. If the actual state is classified as a general anomaly state 6, specific characteristic values 8 are calculated from the current and/or previous measurements 1, for example in the computing unit of the motor. These specific characteristic values 8 may be different from the general characteristic values 2 and may take into account the same input signals 2.1 or other input signals 8.1. The specific characteristic values 8 can be a subset of the general characteristic values 2. The specific characteristic values 8 are in turn used for a comparison 9 with specific limit values 9.1. Based on this comparison 9, an assessment 10 is made as to whether the general anomaly state 6 detected is a general, non-specific anomaly state 11, which is not a specific anomaly state, or is a specific anomaly state 12. If the actual state is classified and assessed as a general, non-specific anomaly state 11, a second signal feedback R2 can be performed for future measurements 1. The result of this assessment 10 can also be transmitted externally as an output signal 13 via defined interfaces for further signal processing 13.1 or saved in an internal and/or external memory. A general but not a specific anomaly state 11 is present if a general anomaly state 6 in the form of a malfunction of the EC motor or the application is diagnosed, which is not to be assessed as a specific anomaly state 12. The further diagnoses of specific anomalies C and D are intermediate stages between the diagnoses A and B. They describe the monitoring for the presence of further specific anomaly states, which are more pronounced than the general anomaly state 6 in the context of diagnosis A and less pronounced than the specific anomaly state 12 in the context of diagnosis B, in each case depending on the presence of a corresponding anomaly state at the previous stage A, C, D—i.e., shown above in FIG. 1. The results of the assessments in the context of diagnoses C and D can also be transmitted externally as an output signal for further signal processing 14, 15. Diagnoses A, B, C, D form a cascade. The specific anomaly state 12 may be a critical anomaly state in the context of diagnosis B.

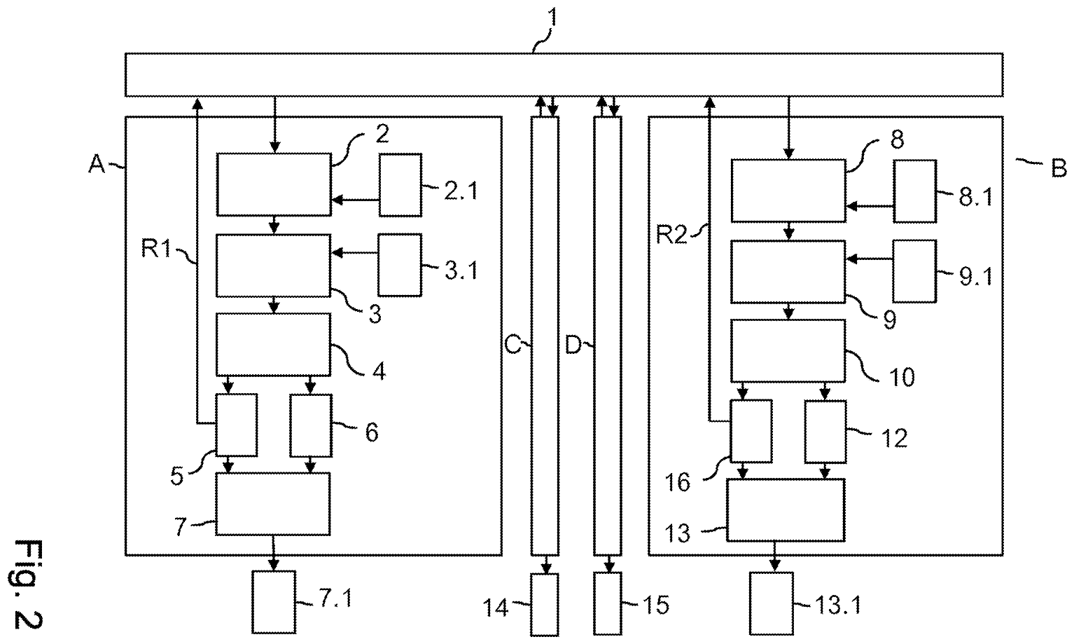

FIG. 2 also shows a flow chart in general. In the left part, a diagnosis of a general anomaly A is shown schematically, corresponding to the diagnosis of a general anomaly A from FIG. 1. However, the diagnosis of a specific anomaly B is not shown below the diagnosis of a general anomaly A in FIG. 2, but in the right part of FIG. 2. The difference between the two embodiments of the method of FIG. 1 and FIG. 2 is that the monitoring of whether a specific anomaly state 12 is present is set up in the method according to FIG. 2 independently of the diagnosis of an anomaly A. This means that the diagnosis of a specific anomaly B, i.e., a specific anomaly state 12, can be performed even if the current actual state and/or previous actual states have not been classified as a general anomaly state 6. This allows the realization of independent or unconditional classifiers. Since monitoring for the presence of a specific anomaly state 12 does not require classification 4 of the actual state as a general anomaly state 6, information that a general, non-specific anomaly state 11 is present is not conveyed during signal feedback R2, but only information that a specific anomaly state 12 is not present 16. A general, non-specific anomaly state 11 can thus be diagnosed with the method according to FIG. 2 if an actual state is classified as a general anomaly state 6 on the basis of the characteristic values 2 on the one hand, but is not assessed as a specific anomaly state 12 on the basis of the characteristic values 8 on the other hand.

If the specific anomaly state 12 is monitored independently of a preceding classification 4 of an actual state as a general anomaly state 6—for example, to monitor natural wear—the diagnosis of a specific anomaly B investigating a near-time system failure can be performed at specific times or continuously. The general diagnosis of a general anomaly A and/or the diagnosis of a specific anomaly B can also be performed individually. The diagnosis of a general anomaly A can be made without further testing for the presence of a specific anomaly state 12. Thus, a possibly general anomaly state 6, which may be classified as a general, non-specific anomaly state 11, is detectable even if a specific anomaly state 12—possibly detected on the basis of other characteristic values or other limit deviations—has already been detected. The further diagnoses C and D in FIG. 2 can refer to other binary classifications and, in an embodiment, monitor further deviating specific anomaly states independently of diagnoses A and B, which refer to deviating and specific damage patterns. On the other hand, one or more further diagnoses C, D may also be at intermediate stages between the general anomaly state 6 monitored with diagnosis A and the specific anomaly state 12 monitored with diagnosis B, especially if the specific anomaly state 12 of diagnosis B is a critical anomaly state. These intermediate stages or the respective presence of their specific anomaly states are then independently monitored.

Overall, one or more diagnoses A, B, C, D, connected in parallel or in series, can be carried out continuously or at defined times on the basis of one or more current or previous characteristic values relating to one or more components of the fan and/or its motor, wherein one or more types of damage to one or more components can be monitored.

With regard to further advantageous embodiments of the device according to the present disclosure, reference is made to the general part of the specification and to the appended claims in order to avoid repetition.

Finally, it should be expressly noted that the above-described exemplary embodiments of the device according to the disclosure serve only to discuss the claimed teaching, but do not limit it to the exemplary embodiments.

### LIST OF REFERENCE NUMBERS

A Diagnosis of a general anomaly
1 Measurement
2.1 Input signal
2 Characteristic values
3 Comparison
3.1 Limit values
4 Classification
5 Anomaly-free normal state
6 General anomaly state
R1 Initial signal feedback
7 Output signal
7.1 Signal processing
B Diagnosis of a specific anomaly
8 Specific characteristic values
8.1 Input signal
9 Comparison
9.1 Specific limit values
10 Assessment
11 General, non-specific anomaly state
12 Specific anomaly state
13 Output signal
13.1 Signal processing
R2 Second signal feedback
C Diagnosis of a specific anomaly as intermediate stage
D Diagnosis of a specific anomaly as intermediate stage
14 Signal processing
15 Signal processing
16 Specific anomaly state not present

1. A method of monitoring the operation of a fan, the method comprising:
performing at least one measurement by detecting at least one input signal over at least one time period,
calculating characteristic values of an actual state based on the measured input signals,
comparing the calculated characteristic values of at least one actual state with limit values,
classifying the actual state on the basis of the comparison either as an anomaly-free normal state or as a general anomaly state, and
monitoring whether at least one specific anomaly state is present.

2. The method according to claim 1, wherein the characteristic values comprise at least one of the following:
results of one or more previous comparisons,
a rotation rate of the fan,
an acceleration in one, two or three spatial axes,
at least one temperature,
a sound pressure,
a torque,
a pressure, in particular an operating or ambient pressure,
humidity values,
measured forces, and/or
virtual values, detected for example by means of soft sensors.

3. The method according to claim 1,
wherein at least one further characteristic value is calculated from a plurality of characteristic values.

4. The method according to claim 1, wherein said monitoring whether a specific anomaly state is present comprises:
calculation of specific characteristic values of at least one state on the basis of the measured input signals,
specific comparison of the calculated specific characteristic values with specific limit values,
assessment of whether a specific anomaly state is present based on the specific comparison, and/or
wherein said monitoring of whether a specific anomaly state is present is independent of any classification of an actual state as a general anomaly state that has already occurred.

5. The method according to claim 1, wherein further specific anomaly states having different expressions are defined.

6. The method according to claim 1, wherein in the case of a classification of the actual state as at least one of:
an anomaly-free normal state; and
an assessment that a general anomaly state is not at the same time a specific anomaly state; and
an assessment that a specific anomaly state is not present,
a signal feedback for at least one future measurement takes place.

7. The method according to claim 1, further comprising:
adjusting a diagnosis taking into account comparisons of characteristic values of at least one past actual state with limit values.

8. The method according to claim 7, wherein
the characteristic values determined by measurements are recorded in a log for consideration in the future adjustment of the diagnosis.

9. A device for monitoring the operation of a fan, comprising:
at least one sensor for detecting at least one input signal over at least one time period for performing at least one measurement, and
a computing unit configured to perform the method according to claim 1.

10. A fan with a device according to claim 9.

11. The method according to claim 5, wherein further specific anomaly states having different expressions form intermediate stages between the general anomaly state and a critical specific anomaly state in which there is a significant malfunction of the fan requiring immediate intervention.

12. The method according to claim 8, wherein the characteristic values determined by measurements are recorded in a log with a time stamp.
